(19) United States
(12) Patent Application Publication
(10) Pub. No.: US 2010/0088602 A1
(43) Pub. Date: Apr. 8, 2010

(54) Multi-Application Control

(75) Inventor: Ronald A. Morris, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/244,955

(22) Filed: Oct. 3, 2008

(51) Int. Cl. G06F 3/01

(52) U.S. Cl. 715/716

(57) ABSTRACT

Multi-application control is described. In embodiment(s), multiple media applications can be processed to generate a media content output from each of the media applications. The media content outputs from the media applications can be displayed together on a display device. A control input can be received to initiate a change to one or more of the media content outputs that are displayed on the display device, and a determination is made as to which of the media content outputs to change when receiving the control input.

### BACKGROUND

Various media devices, such as televisions, personal media players, mobile phones, portable media devices, computer devices, and the like can all have the capability to acquire and playback or render movies, television programs, photos, data feeds, and/or music from various private and public networks, as well as from proprietary marketplaces. Media devices are increasingly used for not only communication, but to store different types of information and data, such as personal and business information, documents, pictures, and other types of data. It is increasingly commonplace to find more television video content, music videos, and images that can be viewed on almost any media device that has a display screen.

User interfaces on the media devices are becoming increasingly complex with the addition of personal media and access to local information. A device can have more than one application running at a given time, such as when a user of a device is looking at photos while playing music. Currently, it may be difficult to control both a photo slideshow and the music at the same time. Typically, a user will have to select the application that controls the photo slideshow and interact with menu selections to display the photos. Alternatively, the user can then select the application that controls playback of the music and interact with menu selections of the different application to control the music. Add to this the notion of a passive display for local information or applications for social networking and it can become burdensome to manage any of the media, and easier to just let the various applications run in a default mode.

### SUMMARY

This summary is provided to introduce simplified concepts of multi-application control. The simplified concepts are further described below in the Detailed Description. This summary is not intended to identify essential features of the claimed subject matter, nor is it intended for use in determining the scope of the claimed subject matter.

Multi-application control is described. In embodiment(s), multiple media applications can be processed to generate a media content output from each of the media applications. The media applications can be processing approximately simultaneously to generate the media content outputs, which can then be displayed together on a display device or on an integrated display of a portable media device. A control input can be received to initiate a change to one or more of the media content outputs that are displayed on a display device. A determination can be made as to which of the media content outputs to change when receiving the control input, and the determination can be based on a respective state of each media content output.

### BRIEF DESCRIPTION OF THE DRAWINGS

Embodiments of multi-application control are described with reference to the following drawings. The same numbers are used throughout the drawings to reference like features and components:

FIG. 1 illustrates an example system in which embodiments of multi-application control can be implemented.

FIG. 2 illustrates example method(s) for multi-application control in accordance with one or more embodiments.

FIG. 3 illustrates various components of an example device that can implement embodiments of multi-application control.

### DETAILED DESCRIPTION

Embodiments of multi-application control provide that a single control input, such as from an input control device or a device selectable input, can initiate a modular, coordinated, and/or sequential control of several media content outputs from various media applications at a media device or on a display device. Sequential control inputs can be initiated with the same selectable control to initiate a change to one or more of the media content outputs, such as display outputs and/or audio outputs. When a control input is received, a determination can be made as to which of one or more media content outputs to change based on a respective state of each media content output.

While features and concepts of the described systems and methods for multi-application control can be implemented in any number of different environments, systems, and/or various configurations, embodiments of multi-application control are described in the context of the following example systems and environments.

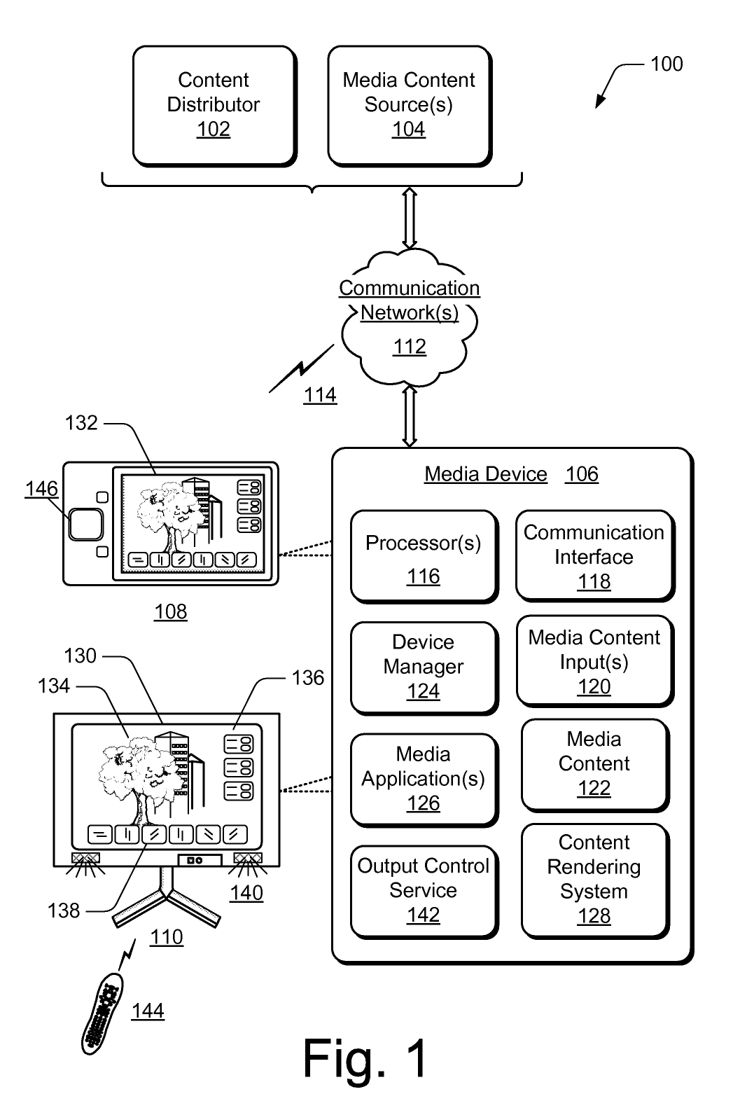

FIG. 1 illustrates an example system 100 in which various embodiments of multi-application control can be implemented. Example system 100 includes a content distributor 102, other media content source(s) 104, and a media device 106 that can be implemented to receive media content from the content distributor 102 and/or any other media content source 104. The media device 106 (e.g., a wired and/or wireless device) can be implemented as any type of portable media device 108 (e.g., a personal media player, portable media player, etc.), an independent display device 110 (e.g., a passive display device), a television client device (e.g., a television set-top box, a digital video recorder (DVR), etc.), a computer device, a portable computer device, a gaming system, an appliance device, an electronic device, and/or as any other type of media device that can be implemented to receive and display or otherwise output media content in any form of audio, video, and/or image data.

A wireless and/or portable media device 108 can include any type of device implemented to receive and/or communicate wireless data, messaging data, and/or voice communications, such as any one or combination of a mobile phone (e.g., cellular, VoIP, WiFi, etc.), a portable computer device, a portable media player, and/or any other wireless media device that can receive media content in any form of audio, video, and/or image data.

The display device 110 can be implemented as any type of a television, high definition television (HDTV), LCD, or similar display system. Display device 110 can be an independent, ambient, or otherwise passive display that may not be monitored or viewed with constant attention, such as for video projection at a music event, an informational board in a public space, or other large or small display device that displays passive information for viewing when the displayed content is of interest to a viewer. Once initiated, the output of a media application can continue to be displayed for any viewer in a public, private, office, or home environment.

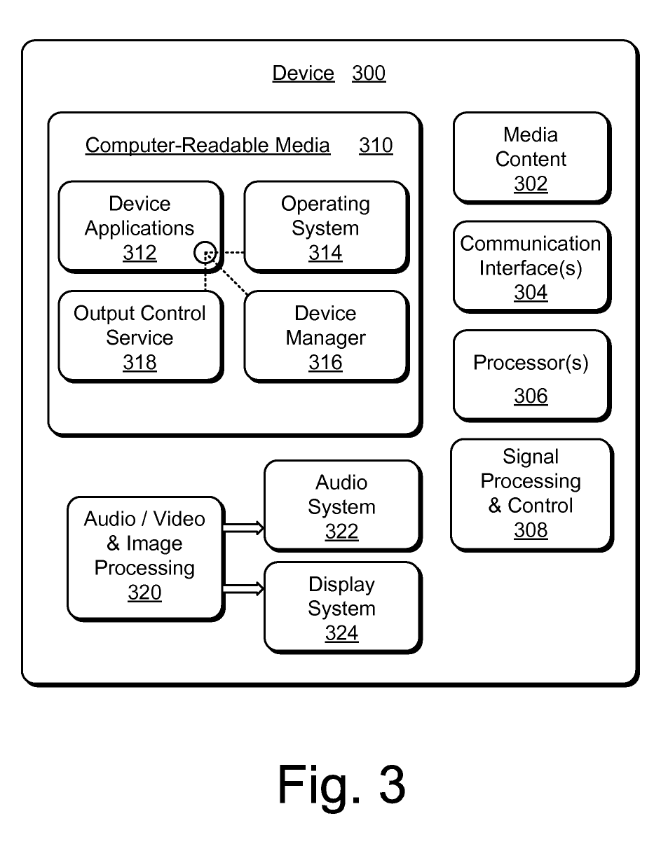

Any of the media devices described herein can be implemented with one or more processors, communication components, media content inputs, memory components, storage media, signal processing and control circuits, and a media content rendering system. A media device can also be implemented with any number and combination of differing components as described with reference to the example device shown in FIG. 3. A media device may also be associated with a user or viewer (i.e., a person) and/or an entity that operates the device such that a media device describes logical devices that include users, software, and/or a combination of devices.

The example system 100 includes content distributor 102 and/or the other media content source(s) 104 that distribute media content to the media devices. In a television distribution system, a television content distributor facilitates distribution of television media content, content metadata, and/or other associated data to multiple viewers, users, customers, subscribers, viewing systems, and/or client devices. Media content (e.g., to include recorded media content) can include any type of audio, video, and/or image media content received from any media content source. As described herein, media content can include television media content, television programs (or programming), advertisements, commercials, music, movies, video clips, data feeds, and on-demand media content. Other media content can include interactive games, network-based applications, and any other content (e.g., to include program guide application data, user interface data, advertising content, closed captions data, content metadata, search results and/or recommendations, and the like).

The media devices and the sources that distribute media content can all be implemented for communication via communication network(s) 112 that can include any type of a data network, voice network, broadcast network, an IP-based network, and/or a wireless network 114 that facilitates data and/or voice communications. The communication network(s) 112 and wireless network 114 can be implemented using any type of network topology and/or communication protocol, and can be represented or otherwise implemented as a combination of two or more networks. Any one or more of the arrowed communication links facilitate two-way data communication, such as from the content distributor 102 to the media device 106 and vice-versa.

In this example system 100, media device 106 includes one or more processors 116 (e.g., any of microprocessors, controllers, and the like), a communication interface 118 for data, messaging, and/or voice communications, and media content input(s) 120 to receive media content 122. Media device 106 also includes a device manager 124 (e.g., a control application, software application, signal processing and control module, code that is native to a particular device, a hardware abstraction layer for a particular device, etc.).

Media device 106 can include various media applications 126 that that can be processed, or otherwise executed, by the processors 116 to generate media content outputs from each of the media applications 126. For example, a photo application can generate a photo slideshow for display on a display device, and a data feed information application can generate a text image, weather information, and/or any other type of news, sports, stocks, and traffic updates for display on a display device. The media applications 126 can also include a music application that generates music, or any other audio application that generates an audio output, such as a news broadcast, radio station broadcast, music or audio that corresponds to a photo slideshow, and the like.

Media device 106 includes a content rendering system 128 that can render the media content outputs from each of the media applications 126 to generate a display 130 of the media content outputs together on display device 110 and/or on an integrated display 132 of portable media device 108. For example, the display 130 of the media content outputs can include a photo 134 (e.g., photos sequencing in a slideshow), sports scores 136 or other information, and images 138 of a music playlist that corresponds to an audio output 140.

Media device 106 also includes an output control service 142 that can be implemented as computer-executable instructions and executed by the processors 116 to implement various embodiments and/or features of multi-application control. In an embodiment, the output control service 142 can be implemented as a component or module of the device manager 124. The output control service 142 can be implemented to control the media content outputs from each of the media applications 126 at media device 106. In various embodiments, the output control service 142 can receive a control input to initiate a change to one or more of the media content outputs, such as those displayed on a display device and/or an audio output.

The device manager 124 can be implemented to monitor and/or receive control inputs (e.g., viewer selections, navigation inputs, application control inputs, etc.) via an input device 144 (e.g., a remote control device or other control input device) that is used to control display device 110, or via selectable input controls 146 on portable media device 108. A single control input can provide modular, coordinated, and/or sequential control of the media content outputs from the media applications 126. For example, sequential control inputs can initiate selection of a new photo or photo album when a first control input is received, initiate selection of a new music playlist when a second control input is received, and initiate selection of a new music track when a third control input is received. The sequential control inputs can be initiated with the same selectable control, such as selectable input control 146 on portable media device 108, and a user does not have to first select the particular media application that controls the media content output and then interact with menu selections of the application.

The output control service 142 can also be implemented to determine which of the media content outputs from the media applications 126 to change based on a respective state of each media content output when a control input is received. The output control service 142 can then communicate with the media applications 126 that are determined to be changed. For example, when a control input is received, the output control service 142 can determine whether to change the display 130 of the photo 134, the sports scores 136, the images 138 of the music playlist, and/or the audio output 140.

If the photo slideshow has displayed all of the photos from a particular photo album, the output control service 142 can determine that the control input is received to initiate selection of a new photo album to continue the photo slideshow with a new set of photos. Alternatively, if all of the songs in the music playlist have been played, the output control service 142 can determine that the control input is received to initiate selection of a new music playlist. Alternatively, if a sporting event has completed and a sports score 136 indicates a final score, the output control service 142 can determine that the control input is received to initiate selection of a different sporting contest to track the score.

In addition, the output control service 142 can determine that a control input is received to initiate a change to more than one of the media content outputs displayed in the display 130. For example, a breaking news event may be displayed when a news media application 126 receives an update and initiates a display of the news event. The output control service 142 can then stop the music audio output 140, the displayed photo 134, and the display of the sports scores 136 so that a video of the breaking news event is displayed for viewing with a corresponding audio output.

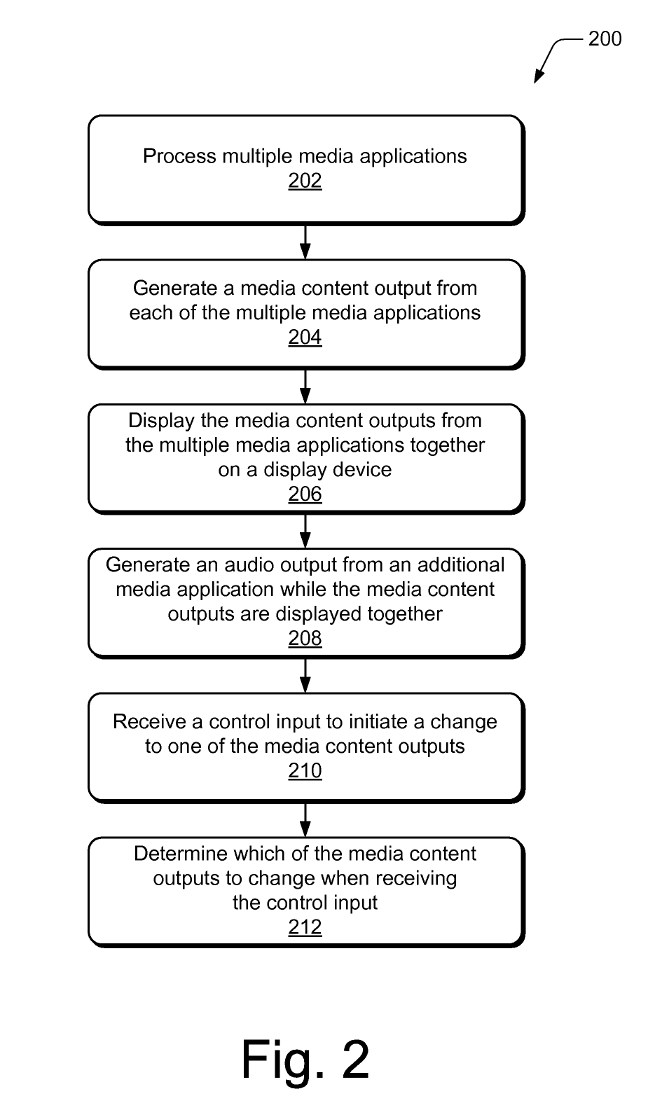

Example method 200 is described with reference to FIG. 2 in accordance with one or more embodiments of multi-application control. Generally, any of the functions, methods, procedures, components, and modules described herein can be implemented using hardware, software, firmware, fixed logic circuitry, manual processing, or any combination thereof. A software implementation of a function, method, procedure, component, or module represents program code that performs specified tasks when executed on a computing-based processor. Example method 200 may be described in the general context of computer-executable instructions, which can include software, applications, routines, programs, objects, components, data structures, procedures, modules, functions, and the like.

The method(s) may also be practiced in a distributed computing environment where functions are performed by remote processing devices that are linked through a communication network. In a distributed computing environment, computer-executable instructions may be located in both local and remote computer storage media, including memory storage devices. Further, the features described herein are platform-independent such that the techniques may be implemented on a variety of computing platforms having a variety of processors.

FIG. 2 illustrates example method(s) 200 of multi-application control. The order in which the method is described is not intended to be construed as a limitation, and any number of the described method blocks can be combined in any order to implement the method, or an alternate method.

At block 202, multiple media applications are processed. For example, media device 106 processes the various media applications 126 which can be processing approximately simultaneously to generate the media content outputs (e.g., from each of the media applications 126). Examples of the media applications 126 include a photo application that generates a photo slideshow for display on a display device, and a data feed information application that generates a text image, weather information, and/or any other type of news, sports, stocks, and traffic updates for display on a display device.

At block 204, a media content output is generated from each of the multiple media applications and at block 206, the media content outputs from the multiple media applications are displayed together on a display device. For example, the media applications 126 each generate a media content output and the content rendering system 128 renders the media content outputs to generate the display 130 of the media content outputs together on display device 110 and/or on the integrated display 132 of portable media device 108.

At block 208, an audio output is generated from an additional media application while the media content outputs from the multiple media applications are displayed together on the display device. For example, the media applications 126 can include an application that generates an audio output, such as a news broadcast, radio station broadcast, music or audio that corresponds to a photo slideshow, and the like.

At block 210, a control input is received to initiate a change to one of the media content outputs. For example, the output control service 142 at media device 106 receives a control input to initiate a change to one or more of the media content outputs, such as an audio output 140 or the media content outputs in display 130 on display device 110 and/or on the integrated display 132 of the portable media device 108. A single control input can provide modular, coordinated, and/or sequential control of the media content outputs from the media applications 126. A control input can be received to initiate a change to one or more of the media content outputs while continuing to display the media content outputs from the multiple media applications together on a display device.

At block 212, a determination is made as to which of the media content outputs to change when receiving the control input. For example, the output control service 142 at media device 106 can determine which of the media content outputs from the media applications 126 to change based on a respective state of each media content output when a control input is received.

FIG. 3 illustrates various components of an example device 300 that can be implemented as any form of a mobile communication, computing, electronic, and/or media device to implement various embodiments of multi-application control. For example, device 300 can be implemented as a media device as shown in FIG. 1.

Device 300 includes media content 302 and one or more communication interfaces 304 that can be implemented for any type of data and/or voice communication via communication network(s). Device 300 also includes one or more processors 306 (e.g., any of microprocessors, controllers, and the like) which process various computer-executable instructions to control the operation of device 300, and to implement embodiments of multi-application control. Alternatively or in addition, device 300 can be implemented with any one or combination of hardware, firmware, or fixed logic circuitry that is implemented in connection with signal processing and control circuits which are generally identified at 308.

Device 300 also includes computer-readable media 310, such as any suitable electronic data storage or memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), any type of a digital versatile disc (DVD), and the like.

Computer-readable media 310 provides data storage mechanisms to store the media content 302, as well as various device applications 312 and any other types of information and/or data related to operational aspects of device 300. For example, an operating system 314 can be maintained as a computer application with the computer-readable media 310 and executed on the processors 306. The device applications 312 can also include a device manager 316, an output control service 318, and various media applications. In this example, the device applications 312 are shown as software modules and/or computer applications that can implement various embodiments of multi-application control as described herein.

Device 300 can also include an audio, video, and/or image processing system 320 that provides audio data to an audio rendering system 322 and/or provides video or image data to an external or integrated display system 324. The audio rendering system 322 and/or the display system 324 can include any devices or components that process, display, and/or otherwise render audio, video, and image data. In an implementation, the audio rendering system 322 and/or the display system 324 can be implemented as integrated components of the example device 300. Although not shown, device 300 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Although embodiments of multi-application control have been described in language specific to features and/or methods, it is to be understood that the subject of the appended claims is not necessarily limited to the specific features or methods described. Rather, the specific features and methods are disclosed as example implementations of multi-application control.

1. A method, comprising:
processing multiple media applications;
generating a media content output from each of the multiple media applications;
displaying the media content outputs from the multiple media applications together on a display device;
receiving a control input to initiate a change to one of the media content outputs that are displayed on the display device; and
determining which of the media content outputs to change when receiving the control input.

2. A method as recited in claim 1, wherein said determining which of the media content outputs to change is based on a respective state of each media content output.

3. A method as recited in claim 1, wherein the control input is received to initiate the change to the media content output while continuing to display the media content outputs from the multiple media applications together on the display device.

4. A method as recited in claim 1, wherein the control input is received to initiate the change to more than one of the media content outputs that are displayed on the display device, and wherein said determining includes determining more than one of the media content outputs to change.

5. A method as recited in claim 1, wherein the multiple media applications are processing approximately simultaneously to generate the media content output from each of the multiple media applications.

6. A method as recited in claim 1, further comprising generating an audio output from an additional media application while the media content outputs from the multiple media applications are displayed together on the display device.

7. A method as recited in claim 6, further comprising receiving the control input to initiate the change to the audio output along with the change to the media content output that is displayed on the display device.

8. A method as recited in claim 6, wherein the multiple media applications include a photo application from which a photo image is generated for display on the display device, and a data feed information application from which a text image is generated for display on the display device, and wherein the additional media application is a music application from which the audio output is generated.

9. A media device, comprising:
a content rendering system configured to generate media content outputs from multiple media applications;
a display device configured to display the media content outputs together as a display;
an output control service configured to:
receive a control input to initiate a change to one of the media content outputs that are displayed on the display device; and
determine which of the media content outputs to change when the control input is received.

10. A media device as recited in claim 9, wherein the output control service is further configured to determine which of the media content outputs to change based on a respective state of each media content output.

11. A media device as recited in claim 9, wherein the output control service is further configured to receive the control input to initiate the change to the media content output while the content rendering system is further configured to continue generation of the media content outputs for display on the display device.

12. A media device as recited in claim 9, wherein the output control service is further configured to:
receive the control input to initiate the change to more than one of the media content outputs that are displayed on the display device; and
determine more than one of the media content outputs to change.

13. A media device as recited in claim 9, further comprising one or more processors configured to process the multiple media applications approximately simultaneously to generate the media content outputs from the multiple media applications.

14. A media device as recited in claim 9, wherein the content rendering system is further configured to generate an audio output from an additional media application while the media content outputs from the multiple media applications are displayed together on the display device.

15. A media device as recited in claim 14, wherein the output control service is further configured to receive the control input to initiate the change to the audio output along with the change to the media content output that is displayed on the display device.

16. A media device as recited in claim 14, wherein the multiple media applications include a photo application from which a photo image is generated for display on the display device, and a data feed information application from which a text image is generated for display on the display device, and wherein the additional media application is a music application from which the audio output is generated.

17. One or more computer-readable media comprising computer-executable instructions that, when executed, initiate an output control service to:
receive a control input to initiate a change to one or more media content outputs that are displayed together on a display device, the media content outputs being generated from multiple media applications that are processed approximately simultaneously; and
determine which of the one or more media content outputs to change when the control input is received.

18. One or more computer-readable media as recited in claim 17, further comprising computer-executable instructions that, when executed, initiate the output control service to determine the one or more media content outputs to change based on a respective state of each media content output.

19. One or more computer-readable media as recited in claim 17, further comprising computer-executable instructions that, when executed, initiate the output control service to change the determined one or more media content outputs for display together on the display device.

20. One or more computer-readable media as recited in claim 17, further comprising computer-executable instructions that, when executed, initiate the output control service to change a media content output that is displayed on the display device to correlate with an audio output that is generated from an additional media content application.
